(19) United States
(12) Patent Application Publication
(10) Pub. No.: US 2006/0107287 A1
(43) Pub. Date: May 18, 2006

(54) Multimedia broadcast/multicast service announcement and notification

(76) Inventors: Kook-Heui Lee, Kyunggi-do (KR); Soeng-Hun Kim, Kyunggi-do (KR); Sung-Ho Choi, Kyunggi-do (KR); Chang Duan, Beijing (CN); Detao Li, Beijing (CN)

Correspondence Address: DILWORTH & BARRESE, LLP, 333 EARLE OVINGTON BLVD., UNIONDALE, NY, 11553, US

(21) Appl. No.: 10/524,715

(22) PCT Filed: Aug. 14, 2003
(86) PCT No.: PCT/KR03/01648

§ 371 Date: Sep. 14, 2005

(30) Foreign Application Priority Data
Aug. 15, 2002 (CN) 021305064

(51) Int. Cl. H04N 7/16; H04N 7/10; H04N 7/025

(52) U.S. Cl. 725/32; 725/62; 725/33

(57) ABSTRACT

The present invention proposes a method of making use of Cell Broadcast to support MBMS transfer service announcement or service notification transfer. The method of transferring service announcement comprises the following steps: CBC commands UTRAN connected with it by a signaling message to send service announcement; UTRAN arranges the prescribed time of sending MBMS service announcement message, adds the brief description information to the schedule message and sends the schedule message; after receiving the schedule message, UE configures physical layer thereof to prepare for receiving MBMS service announcement message. UTARN sends MBMS service announcement message at the prescribed time.

### BACKGROUND OF THE INVENTION

1. Field of Invention

The present invention relates to a method for sending and receiving Multimedia Broadcast/Multicast Service (MBMS) data in communication system, especially to a method of sending and receiving Service Announcement and Service notification in Multimedia Broadcast/Multicast Service with the aid of using cell broadcast.

2. Description of Prior Art

Multimedia Broadcast/Multicast Service (hereinafter referred to as MBMS) is a new service under standardization by 3^{rd} Generation Partnership Project (hereinafter referred to as 3GPP). The standard being developed is TS23.846, whose latest version is 1.1.1. MBMS service is a unidirectional point-to-multipoint (p-t-m) service, whose most remarkable characteristic is that it can make use of radio resources and network resources efficiently.

A system structure of MBMS is described in the following with reference to FIG. 1. As shown in FIG. 1, the MBMS network structure is based on the core network of General Packet Radio Service (hereinafter referred to as GPRS), and further adds new network elements. Broadcast and multicast service center 101 (hereinafter referred to as BM-SC) is the service control center of MBMS system. Gateway GPRS Supporting Node 102 (hereinafter referred to as GGSN) and Service GPRS Supporting Node 103 (hereinafter referred to as SGSN) compose the transmission network of MBMS service and provide route for the transmission of data. Home Location Register 106 (hereinafter referred to as HLR) stores the data related to user and can provide services such as user's authentication. UMTS Terrestrial Radio Access Network 104 (hereinafter referred to as UTRAN) provides radio resources for MBMS service over the air-interface. Uu107 indicates a radio interface between terminal and access network. User Equipment 105 (hereinafter referred to as UE) is a terminal device for receiving data. Cell Broadcast Center 108 (hereinafter referred to as CBC) is a data source of cell broadcast. Radio resources used by MBMS service are not dedicated for one user, but are shared by all users using this service.

A MBMS multicast service flow is described in the following with reference to FIG. 2. As shown in FIG. 2, the MBMS multicast service flow includes the following steps:

In 200, Subscription step, establishes the relationship between user and service provider, which allows the user to receive the related MBMS multicast service.

In 201, Service announcement step, informs UEs about the types and service areas of forthcoming multicast services.

In 202, Joining step, is the process by which a subscriber joins a multicast group, i.e. the user registers the network in which the MBMS multicast service types that he is willing to receive.

In 203, MBMS multicast mode bearer set up step, establishes the network resources for MBMS multicast data transfer.

In 204, MBMS notification step, informs UEs about forthcoming MBMS multicast data transfer.

In 205, Data transfer step, indicates the phase when MBMS multicast service data are transferred from the network to the UEs.

In 206, MBMS multicast mode bearer release step, indicates to release the network resources after MBMS service data transfer finishes.

In 207, Leaving step, corresponding to 202 joining step, indicates that a subscriber is leaving a service group, i.e. the user no longer wants to receive Multicast mode data of a specific service.

The necessary flow of providing a MBMS broadcast service is described with reference to FIG. 3. As shown in FIG. 3, the MBMS broadcast service flow includes the flowing steps:

300, Service announcement step, informs UEs about the types and service areas of forthcoming services.

301, MBMS broadcast mode bearer setup step, establishes the network resources for MBMS broadcast data transfer.

302, MBMS notification step, informs the UEs about the forthcoming MBMS broadcast data transfer.

303, Data transfer step, indicates the phase when MBMS broadcast data are transferred from the network to the UEs.

304, MBMS broadcast mode bearer release step, indicates to release the network resources after MBMS broadcast service data transfer finishes.

In the MBMS Multicast service flow shown in FIG. 2, the operation in step 200, 201 and 202 should be performed for different UEs respectively, and remaining steps are performed by all UEs in the same type of service. The series of steps can be performed repeatedly, and step 200, 201, 203, 204 or 207 can be performed in parallel with other steps.

In the MBMS broadcast service flow shown in FIG. 3, this series of steps can be performed repeatedly and step 300 and 302 can be performed in parallel with other steps.

A Cell Broadcast indicates to transfer data by using a common service channel in a cell so as to enable all UEs staying in the cell capable of receiving the broadcast data of the cell. Refer to 3GPP standard TS25.324 (the latest version is 5.1.0) for the description of cell Broadcast/Multicast Control module BMC.

But in the steps shown in FIGS. 2 and 3, in existing standard TS23.846, it only mentioned that Service announcement steps can be completed by CBC, but the implementation method hasn't been given, and didn't mention with what devices and how to implement MBMS Service notification steps, which make it impossible to completely implement MBMS multicast service flow and MBMS broadcast service flow.

### SUMMARY OF THE INVENTION

Therefore, an object of the present invention is to provide a method on how to use a cell broadcast to realize MBMS service announcement and MBMS service notification so as to make MBMS service be a complete flow. It is noted that the Cell Broadcast herein indicates a method of transmitting data via a common service channel over a air-interface of the cell, and it does not relates to specific devices such as CBC. When the cell broadcast is used to support the MBMS service announcement or MBMS service notification, messages sent from CBC and SGSN can all be sent out through cell broadcast.

According to one aspect of the present invention, a process of a UE receiving MBMS multicast service data is shown in FIG. 4, and includes the following steps:

400, Subscription step, indicates a process of the UE subscribing a specific type of MBMS service, which makes the UE establishing relationship with the specific type of MBMS and be authorized to receive this specific type of MBMS service in the future;

401, Service announcement step, indicates a process of the UE being informed of the MBMS multicast service types and relevant parameters by receiving the service announcement information included in cell broadcast;

402, Joining step, indicates a process of the UE joining the specific MBMS service multicast group, which corresponds to the MBMS service one to one, the multicast group including all subscribers who receive the MBMS service;

403, MBMS Service notification step, indicates that the UE is informed that the MBMS multicast service data, which is expected to receive by the UE, is forthcoming, by receiving MBMS Service notification information included in cell broadcast;

404, Data transfer step, indicates a process of the UE receiving the MBMS service multicast data;

405, Leaving step, indicates a process of the UE leaving the specific MBMS service multicast group that it is used to join.

A Process of a UTRAN sending the MBMS Multicast Service Data is Shown in FIG. 5, and Includes the Following Steps:

500, Service announcement step, indicates that the UTRAN sends information on MBMS service types and service areas via cell broadcast;

501, MBMS multicast mode bearer set up step, indicates a process of co-establishing the network resources for the MBMS service by the UTRAN and a core network;

502, MBMS service notification step, indicates that the UTRAN sends a MBMS service notification message via cell broadcast, the message indicating a forthcoming of a specific MBMS service data, and making all users of this multicast group prepare radio resources;

503, data transfer step, indicates that the UTRAN sends a real MBMS service data;

504, MBMS multicast mode bearer release step, indicates that after the transfer of the MBMS service data being completed, the UTRAN and other devices in the core network co-release the network resources for the MBMS multicast service.

A Process of the UE Receiving the MBMS Broadcast Service Data is Shown in FIG. 6, and Includes the Following Steps:

600, Service announcement step, indicates a process of the UE being informed of the MBMS broadcast service types and relevant parameters by receiving the service announcement information included in the cell broadcast;

601, MBMS service notification step, indicates that the UE is informed that the MBMS broadcast service data, which is expected to receive by the UE, is forthcoming, by receiving MBMS service notification information included in cell broadcast;

603, Data transfer step indicates a process of the UE receiving the MBMS broadcast service data;

A Process of the UTRAN Sending the MBMS Broadcast Service is Shown in FIG. 7, and Includes the Following Steps:

700, Service announcement step, indicates that the UTRAN sends information on MBMS service types and service areas via cell broadcast;

701, MBMS broadcast mode bearer setup step, indicates a process of co-establishing the network resources for the MBMS broadcast service by the UTRAN and the core network;

702, MBMS service notification step, indicates that the UTRAN sends a MBMS service notification message via cell broadcast, the message indicating a forthcoming of a specific MBMS service data, and making all users of this multicast group prepare radio resources;

703, data transfer step, indicates that the UTRAN sends a real MBMS service data;

704, MBMS broadcast mode bearer release step, indicates that after the transfer of the MBMS service data being completed, the UTRAN and other devices in the core network co-release the network resources for the MBMS broadcast service.

According to another aspect of the present invention, the method for transferring service announcement of Multimedia Broadcast/Multicast Service (MBMS) includes the following steps:

(a) Broadcast/Multicast Service Center (BM_SC) requests Cell Broadcast Center (CBC) to send a service announcement by a signaling message in a Multimedia Broadcast/Multicast Service (MBMS) service area, wherein said request can include sending times and sending time duration as parameters;

(b) After receiving the signaling message from BM_SC, Cell Broadcast Center (CBC) commands UMTS Terrestrial Radio Access Network (UTRAN) connected with it to send the service announcement through the signaling message;

(c) UMTS Terrestrial Radio Access Network (UTRAN) arranges the sending of Multimedia Broadcast/Multicast Service (MBMS) service announcement message in a prescribed time of one or more schedule periods according to the requirement of Cell Broadcast Center (CBC), adds brief description information to a schedule message for describing each schedule period and sends the schedule message; after receiving the schedule message, UE analyzes the schedule message and then configures its physical layer to prepare for receiving the Multimedia Broadcast/Multicast Service (MBMS) service announcement message;

(d) UMTS Terrestrial Radio Access Network (UTRAN) sends Multimedia Broadcast/Multicast Service (MBMS) service announcement message at the prescribed time.

Wherein the transfer times in the step (a) can be a plurality of times or infinite times.

In addition, after UMTS Terrestrial Radio Access Network (UTRAN) completes the sending of the Multimedia Broadcast/Multicast Service (MBMS) service announcement message, it may send confirmation information to Cell Broadcast Center (CBC). After receiving the confirmation information from UTRAN, Cell Broadcast Center (CBC) returns confirmation information to BM_SC subsequently.

In the above step (b), according to the requirement of BM_SC, Cell Broadcast Center (CBC) can require UMTS Terrestrial Radio Access Network (UTRAN) to send the service announcement periodically a plurality of times or infinite times.

In the above step (d), UMTS Terrestrial Radio Access Network (UTRAN) sends the Multimedia Broadcast/Multicast Service (MBMS) service announcement message a plurality of times according to the requirement of Cell Broadcast Center (CBC), and the step (c) and (d) can be repeated a plurality of times without a certain precedence order.

In addition, the service announcement message includes parameters of the Multimedia Broadcast/Multicast Service (MBMS) service types and service areas.

According to another aspect of the present invention, the method for transferring a Multimedia Broadcast/Multicast Service (MBMS) service notification includes the following steps:

(a) BM_SC sends the Multimedia Broadcast/Multicast Service (MBMS) data to GGSN;

(b) After receiving said data sent by BM_SC, GGSN sends said data to SGSN by tunneling technique;

(c) After receiving the signals from GGSN, SGSN informs UMTS Terrestrial Radio Access Network (UTRAN) of the forthcoming of the Multimedia Broadcast/Multicast Service (MBMS) data via a signaling message;

(d) Radio data Access Bearer (RAB) is established between UMTS Terrestrial Radio Access Network (UTRAN) and SGSN;

(e) SGSN sends the Multimedia Broadcast/Multicast Service (MBMS) data to UMTS Terrestrial Radio Access Network (UTRAN) via Radio data Access Bearer RAB;

(f) After receiving the described data from SGSN, UMTS Terrestrial Radio Access Network (UTRAN) arranges the sending time of a Multimedia Broadcast/Multicast Service (MBMS) service notification message, which includes to arrange sending at the prescribed time of one or more schedule periods, and to add a brief description information to the schedule message for describing each schedule period and to send the schedule message. After receiving the schedule message, UE analyzes the schedule message and configures its physical layer to prepare for receiving the Multimedia Broadcast/Multicast Service (MBMS) service notification message;

(g) UMTS Terrestrial Radio Access Network (UTRAN) sends the Multimedia Broadcast/Multicast Service (MBMS) service notification message at the prescribed time;

(h) UE requests UTRAN to allocate Radio Bearer (RB) via a signaling message, and a plurality of UEs can send requests to UMTS Terrestrial Radio Access Network (UTRAN) simultaneously;

(i) UMTS Terrestrial Radio Access Network (UTRAN) allocates the radio bearer (RB) according to the number of UEs and other comprehensive factors, and informs the UE;

(j) UMTS Terrestrial Radio Access Network (UTRAN) sends the Multimedia Broadcast/Multicast Service (MBMS) data to the UE via RB.

The above step (e), step (f) and step (g) can be performed without a certain precedence order.

The data transfer flow of MBMS broadcast service is similar with that of multicast service, except that it does not need the step (h), and in the step (i), UMTS Terrestrial Radio Access Network (UTRAN) allocates radio data bearer (RB) according to comprehensive factors without consideration of the number of UEs.

The step of UMTS Terrestrial Radio Access Network (UTRAN) sending a service notification or a service announcement message of Multimedia Broadcast/Multicast Service (MBMS) data via cell broadcast further includes the following steps:

(1) Multimedia Broadcast/Multicast Service Control Module (MBMSC) receives a signaling message sent from the core network nodes (SGSN, CBC), which informs UMTS Terrestrial Radio Access Network (UTRAN) to send a service announcement message or service notification message of Multimedia Broadcast/Multicast Service (MBMS) and includes the necessary parameters for constructing the service announcement message or service notification message of Multimedia Broadcast/Multicast Service (MBMS);

(2) Multimedia Broadcast/Multicast Service Control Module (MBMSC) requests Broadcast/Multicast Control protocol (BMC) with a primitive to send the service announcement message or service notification message of Multimedia Broadcast/Multicast Service (MBMS), wherein said primitive includes the necessary parameters for constructing the service announcement message or service notification message of Multimedia Broadcast/Multicast Service (MBMS);

(3) BMC constructs the service announcement message or service notification message of Multimedia Broadcast/Multicast Service (MBMS), saves it in its own sending memory block, and starts up a counter for this message, and the initial value of the counter is equal to the required times for sending the message, and if the message is required to send for infinite times, the initial value of the counter is assigned with zero or negative value;

(4) BMC estimates the transmission rate (Vneed) needed on the CTCH according to all messages currently saved in the sending memory block, wherein said all messages include the service announcement message or service notification message of Multimedia Broadcast/Multicast Service (MBMS) and other broadcast messages, and if the actual transmission rate (Vctch) on the CTCH is 0, it means that this cell hasn't allocated CTCH resources and it won't continue to send broadcast message, and if the actual transmission rate is much smaller or larger than that needed on the CTCH, BMC reports the actual required transmission rate to RRC with a primitive and requests RRC to establish or adjust CTCH resources, during the period of BMC waiting for CTCH resources configured by RRC, if the actual transmission rate does not match with that required and it isn't equal to zero: when the actual transmission rate is much smaller than that required, BMC can still select some messages with high priority and short length to transfer; when the actual transmission rate is much larger than that needed, BMC also reports to RRC, but at this time, resources on CTCH will be wasted;

(5) RRC controls L1 and L2 with a primitive to establish CTCH or adjust CTCH configuration to make CTCH transmission rate match, and RRC informs BMC the new configuration parameters of CTCH with a primitive, and only if the actual transmission rate is not equal to zero, BMC will still continue to send the broadcast message as described in step (4);

(6) BMC adds descriptions for the service announcement message or service notification message of Multimedia Broadcast/Multicast Service (MBMS) to a pending-for-sending schedule message, and then BMC arranges the service announcement message or service notification message of Multimedia Broadcast/Multicast Service (MBMS) on a certain position of the schedule period following the schedule message for future sending;

(7) BMC sends the schedule message;

(8) BMC sends the service announcement message or service notification message of Multimedia Broadcast/Multicast Service (MBMS) at the prescribed time;

(9) After reducing the counter's value by 1, BMC judges: if the value of the counter is negative, it means that the service announcement message or service notification message of Multimedia Broadcast/Multicast Service (MBMS) is required to send infinite times, then proceeding to step (10) after adding 1 to the value of the counter; if the value of the counter is positive, proceeding to step (10) directly; if the value is zero, it means that the times of sending the service announcement message or service notification message of Multimedia Broadcast/Multicast Service (MBMS) has met the requirement, then BMC returns the confirmation information to Multimedia Broadcast/Multicast Service Control Module (MBMSC) with a primitive and the process of sending service announcement message or service notification message of Multimedia Broadcast/Multicast Service (MBMS) is completed;

(10) BMC waits on-timing according to the time interval that the service announcement message or service notification message of Multimedia Broadcast/Multicast Service (MBMS) is required to send, when the time expires for sending the next service announcement message or service notification message of Multimedia Broadcast/Multicast Service (MBMS), proceeding to step (6).

The step of the UE receiving the service announcement message or service notification message of Multimedia Broadcast/Multicast Service (MBMS) via cell broadcast further includes the following steps:

(1) Multimedia Broadcast/Multicast Service Control Module (MBMSC) sends a request to BMC with a first primitive for receiving a service announcement message or a service notification message of Multimedia Broadcast/Multicast Service (MBMS);

(2) If BMC hasn't received any broadcast message before, proceeding to step (3); otherwise, proceeding to step (9);

(3) BMC informs RRC to receive broadcast message with a second primitive, which includes the parameters that can inform RRC only to receive a BMC preferred message at the prescribed time and to skip some messages;

(4) If RRC has not configured CTCH before, RRC configures link layer (L2) and physical layer (L1) to enable UE to receive information on the CTCH and feedbacks necessary CTCH configuration information with a third primitive to BMC at the same time, thereafter proceeding to step (5); if RRC has configured CTCH resources before, proceeding to step (5) directly;

(5) According to the requirement of BMC, RRC controls L2 and L1 with a fourth primitive to receive cell broadcast information on the CTCH at the prescribed time;

(6) After processing the data frame received from the CTCH accordingly, L1 and L2 submit it to BMC in the format of BMC message with a fifth primitive;

(7) BMC analyses the received message, and if it is the service announcement message or service notification message of Multimedia Broadcast/Multicast Service (MBMS), BMC forwards it to Multimedia Broadcast/Multicast Service Control Module (MBMSC) with a sixth primitive, at the same time the reception is completed; if it is not the service announcement message or service notification message of Multimedia Broadcast/Multicast Service (MBMS), proceeding to step (8);

(8) If the message received by BMC is the schedule message, proceeding to step (9); otherwise, proceeding to step (3);

(9) BMC analyses the schedule message that was received most recently, and checks whether the schedule period described by the schedule message includes the service announcement message or service notification message of Multimedia Broadcast/Multicast Service (MBMS) or not. If it is positive, proceeding to step (12), otherwise, BMC finds the position of the next schedule message and requests RRC to receive the next schedule message with the second primitive;

(10) RRC controls L1 and L2 to receive the next schedule message at the prescribe time with the fourth primitive;

(11) After processing the message received from the CTCH accordingly, L1 and L2 forward the schedule message to BMC with the fifth primitive, and then proceeding to step 9);

(12) BMC finds the position of the Multimedia Broadcast/Multicast Service (MBMS) service announcement message or service notification message, and requests RRC to receive Multimedia Broadcast/Multicast Service (MBMS) service announcement message or service notification message at the prescribed time with the second primitive;

(13) RRC controls L1 and L2 to receive the Multimedia Broadcast/Multicast Service (MBMS) service announcement message or service notification message at the prescribed time with the fourth primitive;

(14) After processing the message received from the CTCH accordingly, L1 and L2 forward the Multimedia Broadcast/Multicast Service (MBMS) service announcement message or service notification message to BMC with the fifth primitive;

(15) BMC forwards the Multimedia Broadcast/Multicast Service (MBMS) service announcement message or service notification message to Multimedia Broadcast/Multicast Service (MBMS) with the third primitive and the reception is completed.

### BRIEF DESCRIPTION OF THE DRAWINGS

The above and other features and advantages of the present invention will be more apparent from the following detailed description taken in conjunction with the accompanying drawings, in which:

FIG. 1 illustrates a diagram of logical network apparatuses that can provide MBMS service.

FIG. 2 illustrates a flow of MBMS multicast service.

FIG. 3 illustrates a flow of MBMS broadcast service.

FIG. 4 illustrates a flow of UE receiving MBMS multicast service data.

FIG. 5 illustrates a flow of UTRAN sending MBMS multicast service data.

FIG. 6 illustrates a flow of UE receiving MBMS broadcast service data.

FIG. 7 illustrates a flow of UTRAN sending MBMS broadcast service data.

FIG. 8 illustrates a message flow of a service announcement process in MBMS service.

FIG. 9 illustrates a message flow of a data transfer in MBMS service.

FIG. 10 illustrates a functional diagram that explains the process of a service announcement and a service notification in MBMS service.

FIG. 11 illustrates an example of mapping CTCH onto S-CCPCH.

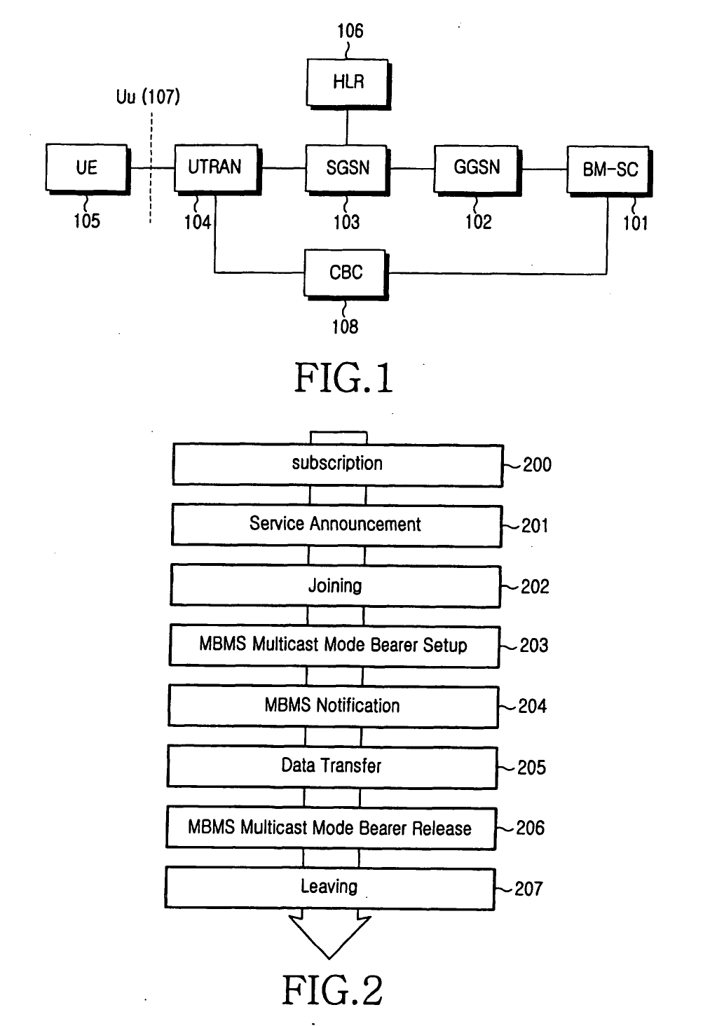

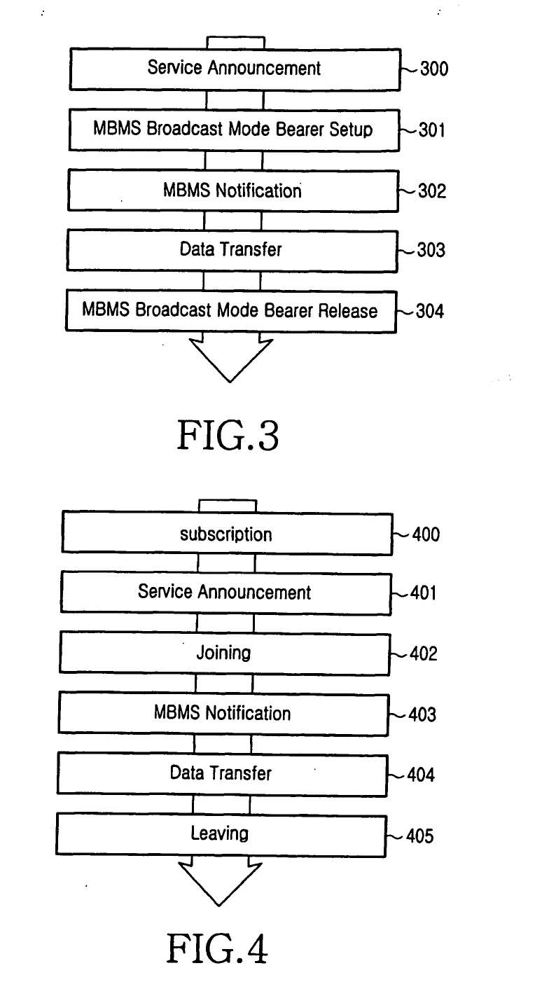

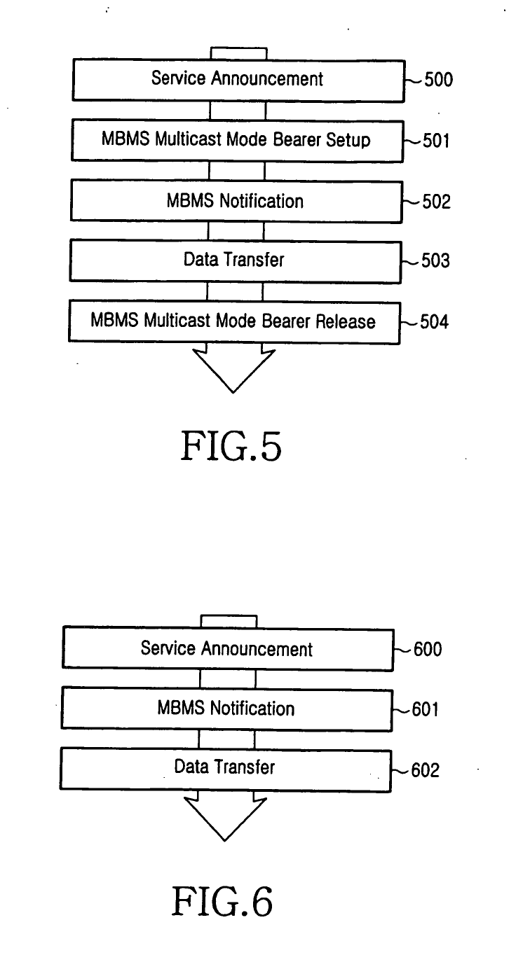

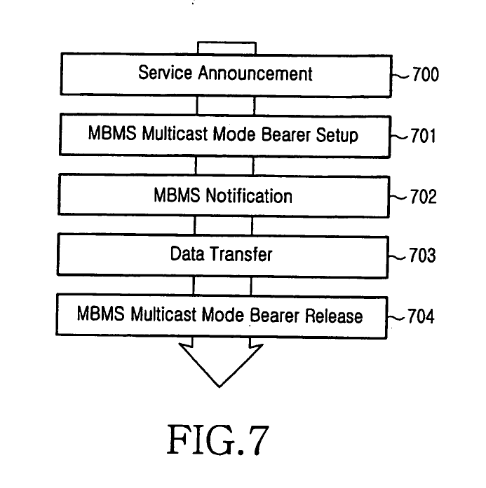

### DETAILED DESCRIPTION OF THE PREFERRED EMBODIMENT

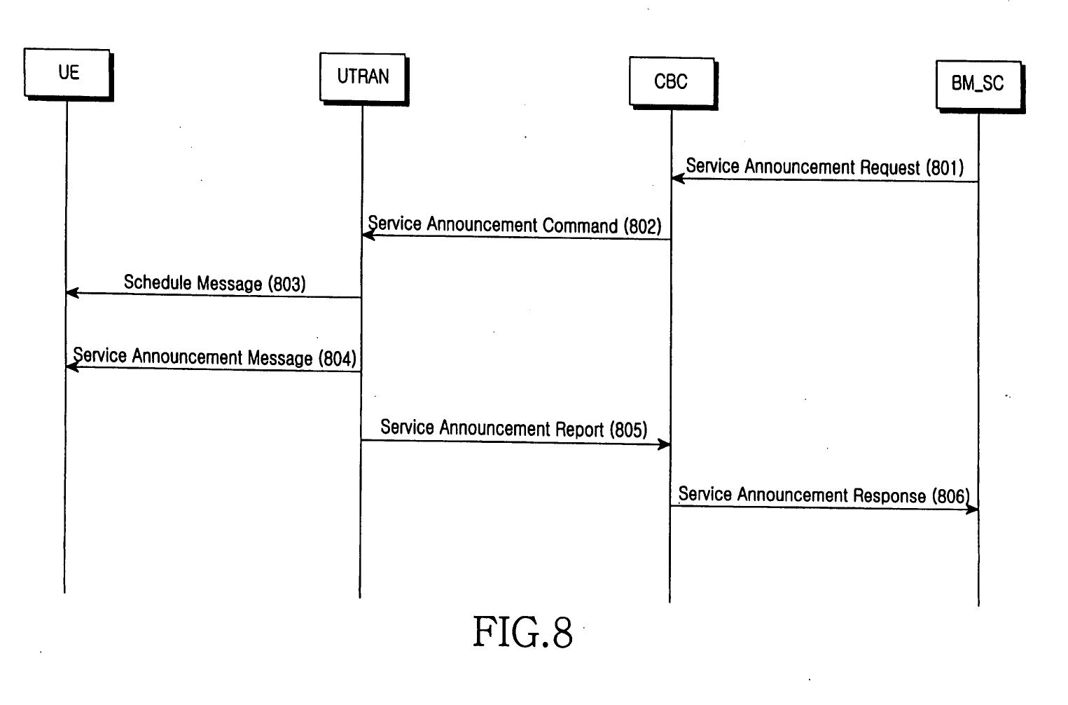

A message flow of a service announcement process in MBMS multicast service In order to explain the process of a service announcement in MBMS service, FIG. 8 gives a message flowchart of a service announcement process, which includes the parts of UE receiving and UTRAN sending. The description is as follows:

801. BM_SC requests CBC to send a service announcement in the service area of MBMS service through a signaling message. This request may include sending times and sending time duration as parameters and the sending times can be infinite times.

802. CBC commands UTRAN connected with it by a signaling message to send the service announcement; according to the requirement of BM_SC, Cell Broadcast Center (CBC) may require UTRAN to send the service announcement periodically a plurality of times or infinite times.

803. UTRAN arranges the time for sending the Multimedia Broadcast/Multicast Service (MBMS) service announcement message in proper time of one or more schedule periods according to the requirement of Cell Broadcast Center (CBC), adds the brief description information to the schedule message that describes each schedule period and sends the schedule message. After receiving the schedule message, UE analyses the schedule message and configures its physical layer to prepare for receiving the Multimedia Broadcast/Multicast Service (MBMS) service announcement message.

804. UTRAN sends the MBMS service announcement message at prescribed time. According to the requirement of CBC, the MBMS service announcement message may be sent a plurality of times, and therefore step 803 and 804 may be repeated a plurality of times without a certain precedence order.

805. After UTRAN completes the sending of the MBMS service announcement message, it sends a confirmation message to CBC.

806. After receiving the confirmation message from UTRAN, CBC returns a confirmation message to BM_SC subsequently.

The flow of a MBMS service announcement is the same as that of a MBMS broadcast service.

A transfer process of a MBMS multicast service data including MBMS service notification process

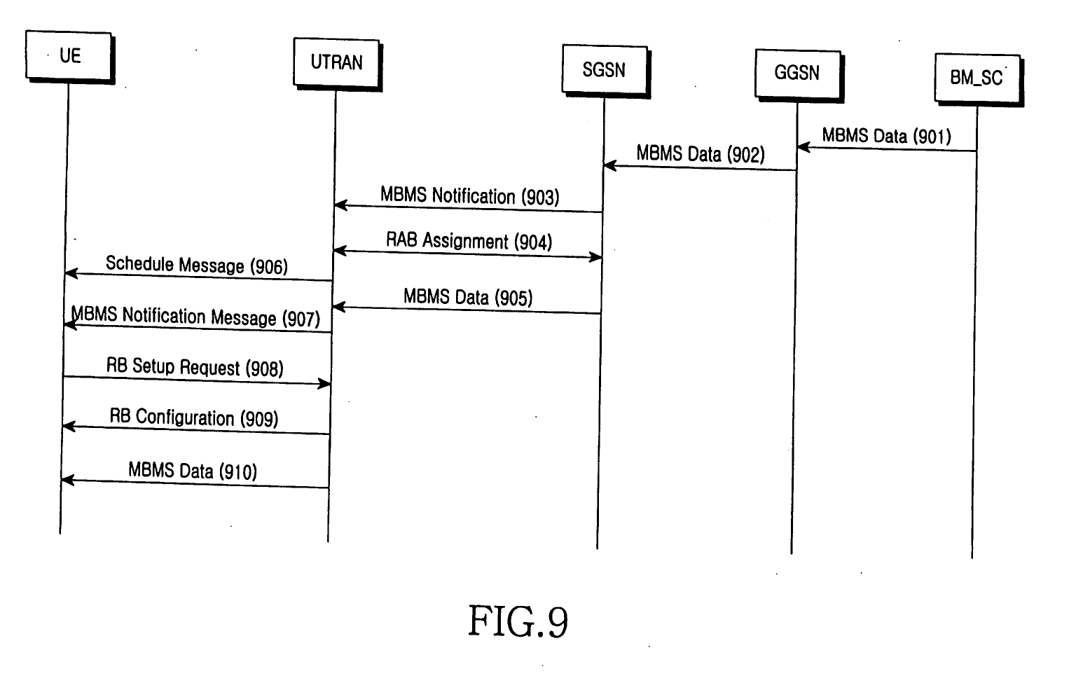

The function of MBMS service notification is to inform UE the forthcoming MBMS data so that UE can prepare radio resources. FIG. 9 is an example of a MBMS data transfer. The function of the MBMS service notification will be explained with reference to the flow of this example:

901, BM_SC initiates an MBMS data transfer and sends MBMS data to GGSN.

902, GGSN sends the data to SGSN by tunneling technique.

903, SGSN informs UTRAN about the forthcoming of the MBMS data by a signaling message.

904, Radio data Access Bearer (hereinafter referred to as RAB) is established between UTRAN and SGSN.

905, SGSN sends MBMS data to UTRAN via RAB. Step 905, 906 and 907 are executed without a certain precedence order.

906, UMTS Terrestrial Radio Access Network (UTRAN) arranges the time for sending the Multimedia Broadcast/Multicast Service (MBMS) service notification message, which includes to arrange it in proper time of one or more schedule periods for sending, to add the brief description information to the schedule message that describes each schedule period and to send the schedule message; after receiving the schedule message, UE analyses the schedule message and configures its physical layer to prepare for receiving the MBMS service notification message.

907, UTRAN sends the MBMS service notification message at the prescribed time.

908, UE requests UTRAN to allocate Radio resources (RB) by a signaling message. It is possible that there are a plurality of UEs to send requests to UTRAN simultaneously at this time.

909, UTRAN allocates radio bearer (hereinafter referred to as RB) according to the number of UEs and other comprehensive factors, and informs UE.

910, UTRAN sends the MBMS data to UE via RB.

The data transfer flow of MBMS broadcast service is similar with that of multicast service, except that it does not need step 908.

A Process of UE Receiving a MBMS Service Announcement Message

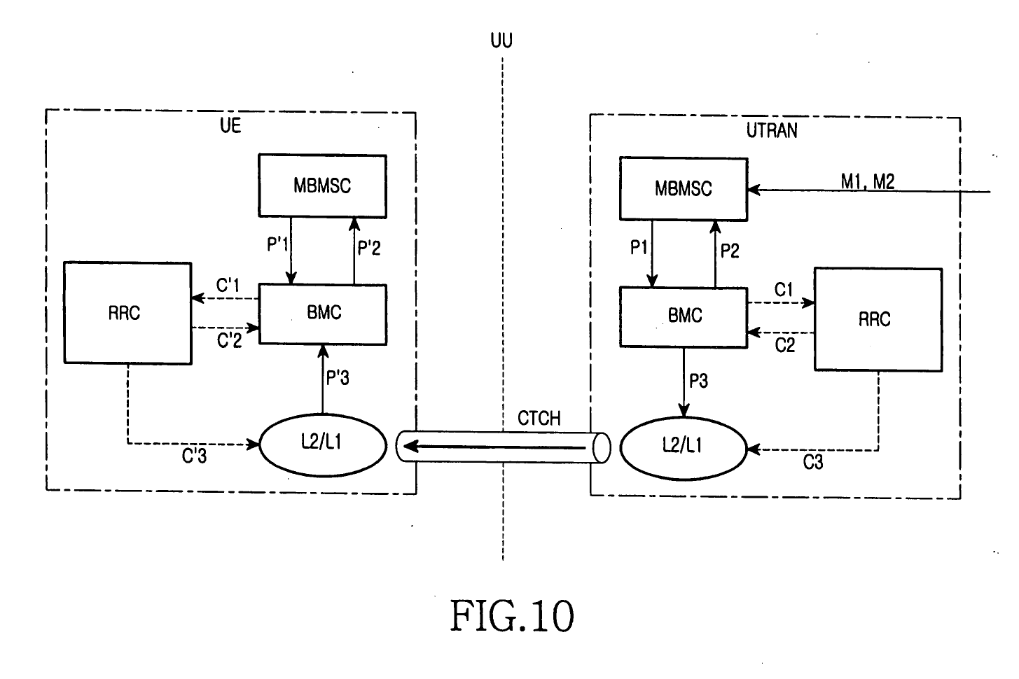

For UE, the process of receiving a MBMS service announcement message in multicast service and in broadcast service is the same. This process will be explained in the following with reference to the functional diagram of FIG. 10:

1. When MBMSC (MBMS Service Control module) decides to receive a MBMS service announcement message, MBMSC sends a request to BMC (Broadcast/Multicast Control protocol) with primitive P′1;

2. If BMC has never received any broadcast message before, proceeding to step 3; otherwise, proceeding to step 9;

3. BMC informs RRC to receive the broadcast message with primitive C′1. The parameters included in C′1 may inform RRC to receive RMC preferred message only at prescribed time and skip some messages. But in step 3, BMC must require RRC to receive all continuous broadcast messages;

4. If RRC has not configured CTCH before, RRC configures link layer (L2) and physical layer (L1) to enable UE to receive information on the CTCH and feedbacks necessary CTCH configuration information to BMC with primitive C′2 at the same time, then proceeding to step 5; if RRC has configured CTCH resources before, proceeding to step 5 directly;

5. According to the requirement of BMC, RRC controls L2 and L1 with primitive C′3 to receive Cell Broadcast Information on the CTCH at the prescribed time; RRC may control L1 to continuously receive CTCH BS (CTCH Block Set) or skip some CTCH BSs;

6. After processing the data frame received from the CTCH accordingly, L1 and L2 submit it to BMC in the format of BMC message (i.e. BMC PDU) with primitive P′3. PDU means Protocol Data Unit, which indicates the message format that BMC can identify and create;

7. BMC analyses the received message. If it is MBMS service announcement message, BMC forwards it with primitive P′2 to MBMSC, at the same time, the reception of this time is completed; otherwise, proceeding to step 8;

8. If the message received by BMC is a schedule message, proceeding to step 9; otherwise, proceeding to step 3;

9. BMC analyses the schedule message that was received most recently, and checks whether the schedule period described by the schedule message includes the Multimedia Broadcast/Multicast Service (MBMS) service announcement message. If so, proceeding to step 12; otherwise, BMC finds the position of the next schedule message and requests RRN to receive the next schedule message with primitive C′1;

10. RRC controls L1 and L2 with primitive C′3 to receive the next schedule message at the prescribed time;

11. After processing the message received from the CTCH accordingly, L1 and L2 forward the schedule message to BMC with primitive P′3, then proceeding to step 9;

12. BMC finds the position of MBMS service announcement message, and requests RRC with primitive C′1 to receive MBMS service announcement message at the prescribed time;

13. RRC controls L1 and L2 with primitive C′3 to receive MBMS service announcement message at the prescribed time;

14. After processing the message received from the CTCH accordingly, L1 and L2 forwards MBMS service announcement message to BMC with primitive P′3;

15. BMC forwards the MBMS service announcement message to MBMS with primitive P′2 and the reception of this time is completed.

Notice:

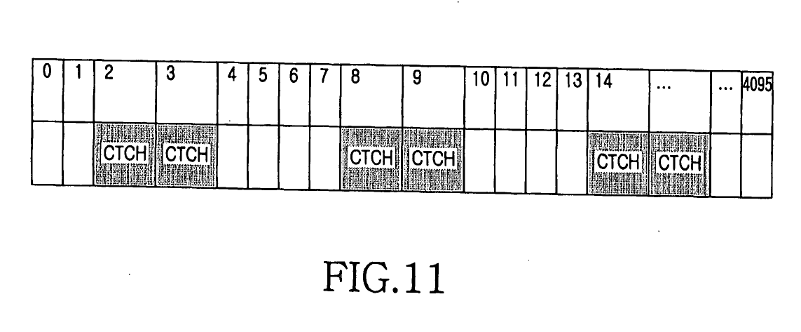

Cell broadcast is transferred through Common Traffic Channel (CTCH), which is a logical channel and is multiplexed with other logical channels into transfer channel FACH together by Medium Access Control sublayer MAC. FACH is then multiplexed together with other transfer channels into physical channel S-CCPCH by physical layer (PHY). An example of CTCH being eventually mapped onto S-CCPCH is shown in FIG. 11, in which CTCH is assigned periodically on the S-CCPCH, and this period is called as CTCH Transfer Interval (CTCH TTI). One CTCH BS that includes the whole or part content of Cell Broadcast Message can be transferred in a CTCH TTI.

Schedule period is composed of a group of CTCH BSs (from 1 to 255). The introduction of schedule period makes CTCH BSs transferred on the CTCH be organized into a continuous schedule period.

A Process of UTRAN Sending MBMS Service Announcement Message

For UTRAN, the process of sending MBMS service announcement message in multicast service and in broadcast service is the same. In addition, this process in all cells controlled by the UTRAN is the same also. This process will be explained in the following with reference to the functional diagram of FIG. 10 by way of one cell as an example:

1. MBMSC receives a signaling message M1 sent from core network node. Here, M1 informs UTRAN to perform the process of MBMS service announcement. M1 includes necessary parameters for MBMS service announcement, such as times for sending MBMS service announcement and the time interval. The core network node that sends M1 signaling message can be SGSN or CBC;

2. MBMSC requests BMC with primitive P1 to send MBMS service announcement message. The primitive P1 includes necessary parameters for constructing MBMS service announcement message;

3. After receiving the primitive P1, BMC constructs MBMS service announcement message and saves it in its own sending memory block, and starts up a counter for this message. The initial value of the counter is equal to the required times of sending message. If the message is required to send for infinite times, the initial value of the counter is assigned with zero or negative value;

4. BMC estimates transmission rate (hereinafter referred to as Vneed) needed on the CTCH according to all messages (including MBMS service announcement messages and other broadcast messages) currently saved in the sending memory block. If the actual transmission rate (hereinafter referred to as Vctch) on the CTCH is 0 (i.e. this cell hasn't allocated CTCH resources) or is much smaller or larger than Vneed, BMC reports the actually needed transmission rate Vneed to RRC with primitive C1 and requests RRC to establish or adjust CTCH resources. During the period of BMC waiting for RRC configuring CTCH resources, if Vctch does not match but it isn't equal to zero: when Vctch is smaller than Vneed, BMC can still select some messages with high priority and short length to transfer; when Vctch is much larger than Vneed, resources on CTCH can completely meet the need of message transfer, but it will only result in waste. So as described above, BMC still needs to report to RRC;

5. RRC controls L1 and L2 with primitive C3 to establish CTCH or adjust CTCH configuration to make CTCH transmission rate match with Vneed. RRC informs BMC the new configuration parameters of CTCH with primitive C2. What need to be mentioned is that after BMC receives the primitive C2, whether CTCH resource adjustment is performed successfully by RRC or not, only if Vctch is not equal to zero, BMC will still continue to send broadcast message as described in step 4;

6. BMC adds descriptions for MBMS service announcement message to a pending-for-sending schedule message, and then BMC arranges MBMS service announcement message on a certain position of the schedule period following the schedule message for future sending;

7. BMC sends the schedule message with primitive P3;

8. BMC sends MBMS service announcement message at the prescribed time with primitive P3;

9. After reducing the counter's value by one, BMC judges: if the value of the counter is negative, it means that MBMS service announcement message is required to send for infinite times, then proceeding to step 10 after adding 1 to the value of the counter; if the value of the counter is positive, proceeding to step 10 directly; if the value is zero, it means that the times of sending MBMS service announcement message has reached the requirement, then BMC returns confirmation information to MBMSC with primitive P2 and the process of MBMS service announcement for this time is completed;

10. BMC waits on-timing according to the time interval that MBMS service announcement message is required to send, and when the time expires for sending the next MBMS service announcement message, proceeding to step 6.

A Process of UE Receiving MBMS Service Notification Message

For UE, the process of receiving MBMS service notification message in multicast service and in broadcast service is the same. This process will be explained in the following with reference to the functional diagram of FIG. 10:

1. When MBMSC (MBMS Service Control module) decides to receive MBMS service notification message, MBMSC sends a request to BMC (Broadcast/Multicast Control protocol) with primitive P′1;

2. If BMC has never received any broadcast message before, proceeding to step 3; otherwise, proceeding to step 9;

3. BMC informs RRC to receive the broadcast message with primitive C′1. The parameters included in C′1 can inform RRC to receive RMC preferred message only at prescribed time and skip some messages. But in step 3, BMC must require RRC to receive all continuous broadcast messages;

4. If RRC has not configured CTCH before, RRC configures link layer (hereinafter referred to as L2) and physical layer (hereinafter referred to as L1) to enable UE to receive information on the CTCH and feedbacks necessary CTCH configuration information with primitive C′2 to BMC at the same time, thereafter proceeding to step 5; if RRC has configured CTCH resources before, proceeding to step 5 directly;

5. According to the requirement of BMC, RRC controls L2 and L1 with primitive C′3 to receive Cell Broadcast Information on the CTCH at the prescribed time; RRC can control L1 to continuously receive CTCH BS or skip some CTCH BSs;

6. After processing the data frame received from the CTCH accordingly, L1 and L2 submit it to BMC in the format of BMC message (i.e. BMC PDU) with primitive P′3. PDU means Protocol Data Unit, which indicates the message format that BMC can identify and create;

7. BMC analyses the received message. If it is a MBMS service notification message, BMC forwards it to MBMSC with primitive P′2, at the same time, the reception of this time is completed; otherwise, proceeding to step 8;

8. If the message received by BMC is a schedule message, proceeding to step 9; otherwise, proceeding to step 3;

9. BMC analyses the schedule message that was received most recently, and checks whether the schedule period described by the schedule message includes MBMS service notification message. If so, proceeding to step 12; otherwise, BMC finds the position of the next schedule message and requests RRC to receive the next schedule message with primitive C′1;

10. RRC controls L1 and L2 with primitive C′3 to receive the next schedule message at the prescribed time;

11. After processing the message received from the CTCH accordingly, L1 and L2 forwards the schedule message to BMC with primitive P′3 and then proceeding to step 9;

12. BMC finds the position of the MBMS service notification message and requests RRC with primitive C′1 to receive MBMS service notification message at prescribed time;

13. RRC controls L1 and L2 with primitive C′3 to receive MBMS service notification message at the prescribed time;

14. After processing the message received from the CTCH accordingly, L1 and L2 forward the MBMS service notification message to BMC with primitive P′3;

15. BMC forwards the MBMS service notification message to MBMSC with primitive P′2 and the reception of this time is completed.

A Process of UTRAN Sending a MBMS Service Notification Message

For UTRAN, the process of sending MBMS service notification message in multicast service and in broadcast service is the same. In addition, this process in all cells controlled by the UTRAN is the same also. This process will be explained in the following with reference to the functional diagram of FIG. 10 by way of one cell as an example:

1. MBMSC receives the signaling message M2 sent from core network node. Here, M2 informs UTRAN to perform the process of MBMS service notification. M2 includes necessory parameters for MBMS service notification, such as times for sending MBMS service announcement and the time interval. The core network node that sends M2 signaling message can be SGSN or CBC;

2. MBMSC requests BMC to send MBMS service notification message with primitive P1. The primitive P1 includes necessary parameters for constructing MBMS service notification message;

3. After receiving the primitive P1, BMC constructs MBMS service notification message and saves it in its own sending memory block, and starts up a counter for this message. The initial value of the counter is equal to the required times of sending message. If the message is required to send for infinite times, the initial value of the counter is assigned with zero or negative value;

4. BMC estimates transmission rate (hereinafter referred to as Vneed) needed on the CTCH according to all messages (including MBMS service notification messages and other broadcast messages) currently saved in the sending memory block. If the actual transmission rate (hereinafter referred to as Vctch) on the CTCH is 0 (i.e. this cell hasn't allocated CTCH resources) or is much smaller or larger than Vneed, BMC reports the actually needed transmission rate Vneed to RRC with primitive C1 and requests RRC to establish or adjust CTCH resources. During the period of BMC waiting for RRC configuring the CTCH resources, if Vctch does not match but it isn't equal to zero: when Vctch is smaller than Vneed, BMC can still select some messages with high priority and short length to transfer; when Vctch is much larger than Vneed, resources on CTCH can completely meet the need of message transfer, but it will only result in waste. So as described in above, BMC still needs to report to RRC;

5. RRC controls L1 and L2 with primitive C3 to establish CTCH or adjust CTCH configuration to make CTCH transmission rate match with Vneed. RRC informs BMC the new configuration parameters of CTCH with primitive C2. It should be noticed that after BMC receives the primitive C2, whether CTCH resource adjustment performed successfully by RRC or not, only if Vctch is not equal to zero, BMC will still continue to send broadcast messages as described in step 4;

6. BMC adds descriptions for MBMS service notification message to a pending-for-sending schedule message, and then BMC arranges MBMS service notification message on a certain position of the schedule period following the schedule message for future sending;

7. BMC sends the schedule message with primitive P3;

8. BMC sends MBMS service notification message at the prescribed time with primitive P3;

9. After reducing the counter's value by one, BMC judges: if the value of the counter is negative, it means that MBMS service notification message is required to send for infinite times, then proceeding to step 10 after adding 1 to the value of the counter; if the value of the counter is positive, proceeding to step 10 directly; if the value is zero, it means that the times of sending MBMS service notification message has met the requirement, then BMC returns confirmation information to MBMSC with primitive P2 and the process of MBMS Service notification for this time is completed;

10. BMC waits on-timing according to the time interval that MBMS service notification message is required to send. When the time expires for sending the next MBMS service notification message, proceeding to step 6.

Message Structures Used in the Processes of MBMS Service Announcement and MBMS Service Notification

Schedule Message

A schedule message occupies one or more CTCH BSs included in a schedule period. The schedule message describes the schedule period that directly follows the schedule message to which the schedule message belongs, which makes continuous schedule messages be able to describe continuous schedule periods. Its structure is shown in Table 1.

TABLE 1
structure of schedule message

| Information Element | | Plurality | |
|---|---|---|---|
| (IE) | Need | existence | Semantics description |
| Message Type | necessary | | |
| Offset to Begin CTCH | necessary | | |
| BS_{index} | | | |
| Length of Scheduling | necessary | | |
| Period | | | |
| New Message Bitmap | necessary | | |
| Message Description | necessary | 1 To <the | Message description |
| | | length of | includes a plurality of |
| | | schedule | items, wherein each item |
| | | period> | describes the message |
| | | | content included in one |
| | | | CTCH BS of the |
| | | | schedule period. The i-th |
| | | | item corresponds to the i- |
| | | | th bit of new message |
| | | | bitmap. |

Message Type, the sub-information element in schedule message, is included in all the cell broadcast message. It describes the message types, whose coding is shown in Table 2.

TABLE 2
Coding of Information Element in Schedule Message

| | |
|---|---|
| 1 | CBS Message |
| 2 | Schedule Message |
| 3 | CBS41 Message |
| 4 | MBMS Service Announcement |
| | Message |
| 5 | MBMS Service Notification |
| | Message |
| 0, 6 . . . 255 | Reserved for future use (PDU with |
| | any coding herein shall be discarded |
| | by the protocol of this version.) |

New message bitmap, the sub-information element in schedule message, is a map of bits, each bit of which corresponding to a CTCH BS in the schedule period. The bit value is 1, which indicates that CTCH BS includes a new message, and the bit value is 0, which indicates that CTCH BS includes an old message, whose structure is shown in Table 3.

TABLE 3
structure of new message bitmap of
Information Element in schedule message

| | | | | | | | | |
|---|---|---|---|---|---|---|---|---|
| CTCH | CTCH | CTCH | . . . | | | | | 1 |
| BS | BS | BS | | | | | | |
| Index | Index | Index | | | | | | |
| B | B + 1 | B + 2 | | | | | | |
| | | | | | | | | 2 |
| | | | | | | | | . . . |
| | . . . | CTCH | CTCH | 0 | 0 | 0 | 0 | n |
| | | BS | BS | | | | | |
| | | Index | Index | | | | | |
| | | E-1 | E | | | | | |

There is a plurality of sub-information element message descriptions in a schedule message, whose number is equal to the number of CTCH BSs included in the schedule period described by the schedule message. Each CTCH BS is described by one message description, whose structure is shown in Table 4.

TABLE 4
structure of Information Element Message description in schedule message

| Information Element | | | Semantics |
|---|---|---|---|
| (IE) | Need | Type | description |
| Message | necessary | Enumerated value | |
| Description Type | | (0 . . . 255) | |
| | | Table 5 | |
| Message ID | Decision | Enumerated value | |
| | condition | (0 . . . 2¹⁶ − 1) | |
| | MDT11 | | |
| Offset to CTCH BS | Decision | Integer | |
| index of first | condition | (0 . . . 255) | |
| transmission | MDT22 | | |
| MBMS service | Decision | IP | This Information |
| Identity | condition | multicast-address | Element is used to |
| | MDT33 | | identify the types of |
| | | | MBMS service |
| MBMS service | Decision | TMGI | This Information |
| Identity | condition | | Element is used to |
| | MDT44 | | identify the type of |
| | | | MBMS service. |

The types of the message included by CTCH BSs are described by the Sub-information Element Message Description Type of Message Description Information Element, whose coding is shown in Table 5.

TABLE 5
Coding of the types of Sub-information Element Message
Description in Message Description Information Element

| Values | Interpretation |
|---|---|
| 0 | Repetition of new BMC message within schedule period |
| 1 | New messge |
| 2 | Reading advised |
| 3 | Reading optional |
| 4 | Repetition of old BMC message within schedule period |
| 5 | Old message |
| 6 | Schedule message |
| 7 | CBS41 message |
| 8 | MBMS service announcement message |
| 9 | MBMS serivce notification message |
| 10. 255 | Reserved for future use |

Since except for Message Description Types, other Sub-information Elements do not absolutely exist, their existence is determined by the decision conditions. The decision condition for each Sub-information existence is shown in Table 6.

TABLE 6
Decision Conditions for deciding whether a certain Sub-
information Elements exist in Information Element Message Description

| Decision condition | Interpretation |
|---|---|
| MDT11 | If Message Description Types = 1 or 5, then: |
| | The Information Element of Message Idenity exists. |
| MDT22 | If Message Description Types = 0 or 4, then: |
| | The Information Element of Offset to CTCH BS |
| | index of first transmission exists and indicates the |
| | offset of CTCH BS that is the first one including |
| | broadcast message in this schedule period to |
| | schedule message. |
| MDT33 | If the Message Description Types = 8 (MBMS |
| | service announcement message) and the message |
| | structure in Table 8 is selected for use, then: |
| | The Information Element of MBMS service Identity |
| | exists and is identified by IP multicast address; |
| MDT44 | If the Message Description Types = 9 (MBMS |
| | service notification message), then: The Information |
| | of MBMS service Identity exists and is identified |
| | by TMGI; |

MBMS Service Announcement Message

MBMS service announcement message describes parameters such as MBMS service types and service areas, and may have two kinds of structures: the first kind of structure describes a plurality of MBMS services, as shown in Table 7; and the second kind of structure describes single MBMS service, as shown in Table 8.

TABLE 7
structure of the first kind of MBMS service announcement message

| Information Element | | |
|---|---|---|
| (IE) | Need | Semantics description |
| Message Type | necessary | |
| Service Number | necessary | The number of MBMS services |
| | | described in the message |
| MBMS service Identity 1 | | The Identity of the first MBMS |
| | | service: IP multicast address |
| APN 1 | | The domain name of access point, |
| | | for pointing to one GGSN |
| UE capability 1 | | The capability of UE required |
| | | by the first MBMS service |
| . . . | | |
| MBMS service Identity n | | The Identity of the n-th MBMS |
| | | service, n = Service Number |
| APN n | | |
| UE capability n | | The capability of UE required |
| | | by the n-th MBMS service |

TABLE 8
structure of the second kind of MBMS service announcement message

| Information Element | | |
|---|---|---|
| (IE) | Need | Semantics description |
| Message Type | necessary | |
| MBMS Service Identity | | Identity of this MBMS service: |
| | | IP multicast address |
| APN | | |
| UE capability | | |

MBMS Service Notification Message

MBMS service notification message is notification information about a certain forthcoming MBMS service and informs UE to prepare for the MBMS service. Its structure is shown in Table 9.

TABLE 9
structure of MBMS service notification message

| Information Element | | |
|---|---|---|
| (IE) | Need | Semantics description |
| Message Type | necessary | |
| MBMS Service Group | necessary | Identity of the MBMS service |
| Identity | | group: TMGI |
| QoS QOS | necessary | Quality of Service that can be |
| | | provided by this MBMS service |
| Random Mechanism | Optional | Pre-coding random mechanism |
| Random Value | Optional | |
| Mask Value | Optional | |

To avoid the air congestion resulted from simultaneous responses to access network when a plurality of UEs receive MBMS service notification message simultaneously, there should be such a mechanism that allows large number of UEs to respond at different time. Sub-information Element random mechanism, random value and mask value in the MBMS service notification message are all set for this. Random mechanism indicates which operation mode to be used by coding. IMSI of UE (the unique ID of an UE over the world), random value and mask value are participated in operation together and the operation results is used as time delay that UE initiates a response with time as the unit (e.g. millisecond). Table 10 shows the coding modes of random mechanism.

TABLE 10
coding of random mechanism of Sub-information Element in
MBMS service notification message

| | |
|---|---|
| 0 | After IMSI modulo the random value, performing |
| | bit-by-bit AND operation with the mask value. |
| 1 | After IMSI adding to the random value, |
| | performing bit-by-bit AND operation with the |
| | mask value. |
| 2 | After IMSI multiplying with the random value, |
| | performing bit-by-bit AND operation with the |
| | mask value. |
| 3 | After IMSI dividing by the random value, |
| | performing bit-by-bit AND operation with the |
| | mask value. |

### EFFECTS OF THE INVENTION

1. Effectively use the network resources: since the processes of MBMS service announcement and service notification are all performed via cell broadcast, the one-to-multiple characteristic of cell broadcast reduces the load of resources resulted from these two processes effectively;
2. Effectively reduce the standby time of UEs: since cell broadcast enable UEs to receive cell broadcasts in discontinuous mode, it remarkablely increases the lifetime of UEs' batteries;

Scalability: since cell broadcast uses messages of variable length, it can add parameters for future use effectively.

What is claimed is:

1. A method for transferring a service announcement of Multimedia Broadcast/Multicast Service (MBMS) comprises the following steps:
(a) Broadcast/Multicast Service Center (BM_SC) requests Cell Broadcast Center (CBC) to send a Service Announcement message, wherein said request may include sending times and sending time duration as parameters;
(b) After receiving a message from the BM_SC, the Cell Broadcast Center (CBC) commands UMTS Terrestrial Radio Access Network (UTRAN) connected with it by a message to send the service announcement;
(c) UMTS Terrestrial Radio Access Network (UTRAN) arranges the time for sending the Multimedia Broadcast/Multicast Service (MBMS) service announcement message at one or more schedule periods according to the requirement of Cell Broadcast Center (CBC), adds a brief description information to a schedule message that describes each of the schedule periods and sends the schedule message;
(d) UMTS Terrestrial Radio Access Network (UTRAN) sends the Multimedia Broadcast/Multicast Service (MBMS) service announcement message.

2. The method according to claim 1, wherein transfer times in the step (a) can be a plurality times or infinite times.

3. The method according to claim 1, wherein after finishing sending the Multimedia Broadcast/Multicast Service (MBMS) service announcement message, UMTS Terrestrial Radio Access Network (UTRAN) sends confirmation information to Cell Broadcast Center (CBC).

4. The method according to claim 3, wherein after receiving the confirmation information from UTRANUTRAN, Cell Broadcast Center (CBC) returns confirmation information to Broadcast/Multicast Service Center (BM_SC) subsequently.

5. The method according to claim 1, wherein in the step (b), according to the requirement of Broadcast/Multicast Service Center (BM_SC), Cell Broadcast Center (CBC) can require UMTS Terrestrial Radio Access Network (UTRAN) to send the service announcement periodically a plurality of times or infinite times.

6. The method according to claim 1, wherein in the step (d), UMTS Terrestrial Radio Access Network (UTRAN) sends the Multimedia Broadcast/Multicast Service (MBMS) service announcement message a plurality of times according to the requirement of Cell Broadcast Center (CBC), and the step (c) and the step (d) can be repeated a plurality of times without a certain precedence order.

7. The method according to claim 1, wherein the service announcement message includes parameters of service types and service areas of Multimedia Broadcast/Multicast Service (MBMS).

8. The method according to claim 7, wherein the step of UMTS Terrestrial Radio Access Network (UTRAN) sending a service announcement message that includes the service types and service areas of Multimedia Broadcast/Multicast Service (MBMS) via Cell Broadcast further comprises the following steps:
(1) Multimedia Broadcast/Multicast Service (MBMS) Control Module (MBMSC) receives a signaling message from core network nodes (SGSN, CBC), which informs UMTS Terrestrial Radio Access Network (UTRAN) to send the Multimedia Broadcast/Multicast Service (MBMS) service announcement message;
(2) Multimedia Broadcast/Multicast Service Control Module (MBMSC) requests Broadcast/Multicast Control protocol (BMC) to send the Multimedia Broadcast/Multicast Service (MBMS) service announcement message;
(3) BMC constructs the Multimedia Broadcast/Multicast Service (MBMS) service announcement message and saves it in a sending memory block thereof, and starts up a counter for this message, wherein a initial value of the counter is equal to the required times of sending the message, and if the message is required to be sent infinite times, the initial value of the counter is assigned with zero or negative value;
(4) BMC estimates a transmission rate (Vneed) needed on CTCH according to all the messages currently saved in the sending memory block, wherein all the messages include the Multimedia Broadcast/Multicast Service (MBMS) service announcement messages and other broadcast messages, and if the actual transmission rate (Vctch) on the CTCH is 0, it means that this cell hasn't allocated CTCH resources and it won't continue to send broadcast message, and if the actual transmission rate is much smaller or larger than that needed on the CTCH, BMC reports the actual required transmission rate to RRC with a primitive and requests RRC to establish or adjust CTCH resources, and during the period of BMC waiting for RRC configuring CTCH resources, if the actual transmission rate does not match with that needed but it isn't equal to zero: when the actual transmission rate is smaller than that needed, BMC may still select some messages with high priority and short length to transfer; when the actual transmission rate is much larger than that needed, BMC also reports to RRC, but at this time, resources on CTCH exceeds the requirement of message transmission, and are wasted;
(5) RRC controls L1 and L2 with a primitive to establish CTCH or adjust CTCH configuration so as to make CTCH transmission rate match, and informs BMC of the new configuration parameters of CTCH with a primitive, and only if the actual transmission rate is not equal to zero, BMC will still continue to send broadcast messages as described in step (4);
(6) BMC adds descriptions for the Multimedia Broadcast/Multicast Service (MBMS) service announcement message to a pending-for-sending schedule message, and then arranges the Multimedia Broadcast/Multicast Service (MBMS) service announcement message on a specific position of the schedule period following the schedule message for future sending;
(7) BMC sends the schedule message;
(8) BMC sends the Multimedia Broadcast/Multicast Service (MBMS) service announcement message at the prescribed time;
(9) After reducing the counter's value by 1, BMC judges: if the value of the counter is negative, it means that the Multimedia Broadcast/Multicast Service (MBMS) service announcement message is required to send for infinite times, then proceeding to step (10) after adding 1 to the value of the counter; if the value of the counter is positive, proceeding to step (10) directly; if the value is zero, it means that the times of sending the Multimedia Broadcast/Multicast Service (MBMS) service announcement message has met the requirement, then BMC return the confirmation information to Multimedia Broadcast/Multicast Service Control Module (MBMSC) and the process of sending the Multimedia Broadcast/Multicast Service (MBMS) service announcement for this times is completed;
(10) BMC waits on-timing according to the time interval that Multimedia Broadcast/Multicast Service (MBMS) service announcement message is required to send, and when the time expires for sending a next Multimedia Broadcast/Multicast Service (MBMS) service announcement message, proceeding to step (6).

9. The method according to claim 7, wherein the step of UE receiving the service announcement message for the parameters of the service types and service areas of Multimedia Broadcast/Multicast Service (MBMS) via cell broadcast further comprises the following steps:
(1) Multimedia Broadcast/Multicast Service (MBMS) Service Control Module (MBMSC) sends a request for receiving a Multimedia Broadcast/Multicast Service (MBMS) service announcement message to BMC with a first primitive;
(2) If BMC has never received any broadcast message before, proceeding to step (3); otherwise, proceeding to step 9);
(3) BMC informs RRC to receive a broadcast message with a second primitive, which includes the parameters that can inform RRC to receive BMC preferred message at the prescribed time and to skip some messages;
(4) If RRC has not configured CTCH before, RRC configures link layer (L2) and physical layer (L1) to enable UE to receive information on CTCH and feedbacks necessary CTCH configuration information with a third primitive to BMC at the same time, thereafter proceeding to step (5); if RRC has configured CTCH resources before, proceeding to step (5) directly;
(5) According to the requirement of BMC, RRC controls L2 and L1 with a fourth primitive to receive cell broadcast information on CTCH at the prescribed time;
(6) After processing the data frame received from the CTCH accordingly, L1 and L2 submit the data frame to BMC in the format of BMC message with a fifth primitive;
(7) BMC analyses the received message, and if it is a Multimedia Broadcast/Multicast Service (MBMS) service announcement message, BMC forwards it to Multimedia Broadcast/Multicast Service Control Module (MBMSC) with a sixth primitive, and at the same time, reception of this time is completed; if it is not a Multimedia Broadcast/Multicast Service (MBMS) service announcement message, proceeding to step (8);
(8) If the message received by BMC is a schedule message, proceeding to step (9); otherwise, proceeding to step (3);
(9) BMC analyses the schedule message received most recently, and checks if the schedule period described by the schedule message includes the Multimedia Broadcast/Multicast Service (MBMS) service announcement message, if so, proceeding to step (12); otherwise, BMC finds the position of the next schedule message and requests RRC to receive the next schedule message with the second primitive;
(10) RRC controls L1 and L2 with the fourth primitive to receive the next schedule message at the prescribed time;
(11) After processing the message received from CTCH accordingly, L1 and L2 forward the schedule message to BMC with the fifth primitive, and then proceeding to step (9);
(12) BMC finds the position of the Multimedia Broadcast/Multicast Service (MBMS) service announcement message and requests RRC with the second primitive to receive the Multimedia Broadcast/Multicast Service (MBMS) service announcement message at prescribed time;
(13) RRC controls L1 and L2 with the fourth primitive to receive Multimedia Broadcast/Multicast Service (MBMS) service announcement message at the prescribed time;
(14) After processing the message received from CTCH accordingly, L1 and L2 forward the Multimedia Broadcast/Multicast Service (MBMS) service announcement message to BMC with the fifth primitive;
(15) BMC forwards the Multimedia Broadcast/Multicast Service (MBMS) service announcement message to Multimedia Broadcast/Multicast Service (MBMS) Control Module (MBMSC) with the third primitive and the reception for this time is completed.

10. A method for transferring a service notification of Multimedia Broadcast/Multicast Service (MBMS) comprises the following steps:
(a) BM_SC sends Multimedia Broadcast/Multicast Service (MBMS) data to GGSN;
(b) After receiving the data sent by BM_SC, GGSN sends the data to SGSN;
(c) After receiving the signals from GGSN, SGSN informs UMTS Terrestrial Radio Access Network (UTRAN) of the forthcoming of the Multimedia Broadcast/Multicast Service (MBMS) data via a signaling message;
(d) Radio data Access Bearer (RAB) is established between UMTS Terrestrial Radio Access Network (UTRAN) and SGSN;
(e) SGSN sends the Multimedia Broadcast/Multicast Service (MBMS) data to UMTS Terrestrial Radio Access Network (UTRAN) via radio data access bearer (RAB);
(f) After receiving the data from SGSN, UMTS Terrestrial Radio Access Network (UTRAN) arranges time for sending the Multimedia Broadcast/Multicast Service (MBMS) service notification message;
(g) UMTS Terrestrial Radio Access Network (UTRAN) sends the Multimedia Broadcast/Multicast Service (MBMS) service notification message at a prescribed time;
(h) UE requests UTRAN to allocate radio resources (RB) via a signaling message, and a plurality of other UEs can send requests to UMTS Terrestrial Radio Access Network (UTRAN);
(i) UMTS Terrestrial Radio Access Network (UTRAN) allocates radio bearer (RB) according to the number of UEs;
(j) UMTS Terrestrial Radio Access Network (UTRAN) sends the Multimedia Broadcast/Multicast Service (MBMS) data to UE via RB.

11. The method according to claim 10, wherein the step (e), step (f) and step (g) can be performed without a certain precedence order.

12. The method according to claim 10, wherein the service notification message indicates the forthcoming of specific Multimedia Broadcast/Multicast Service (MBMS) data and includes relevant parameters related to the Multimedia Broadcast/Multicast Service (MBMS).

13. The method according to claim 12, wherein the step of UMTS Terrestrial Radio Access Network (UTRAN) sending the Multimedia Broadcast/Multicast Service (MBMS) service notification message via cell broadcast further comprises the following steps:
(1) Multimedia Broadcast/Multicast Service (MBMS) Service Control Module (MBMSC) receives a signaling message sent from core network node (SGSN, CBC), which informs UMTS Terrestrial Radio Access Network (UTRAN) to perform the process of Multimedia Broadcast/Multicast Service (MBMS) service notification;
(2) Multimedia Broadcast/Multicast Service Control Module (MBMSC) requests Broadcast/Multicast Control protocol (BMC) to send the Multimedia Broadcast/Multicast Service (MBMS) service notification message;
(3) BMC constructs the Multimedia Broadcast/Multicast Service (MBMS) service notification message and saves it in a sending memory block thereof;
(4) BMC estimates a transmission rate (Vneed) needed on CTCH according to all the messages currently saved in the sending memory block, all the messages include the Multimedia Broadcast/Multicast Service (MBMS) service notification messages;
(5) RRC controls L1 and L2 with a primitive to establish CTCH or adjust CTCH configuration so as to make CTCH transmission rate match with the transmission rate needed (Vneed), and informs BMC the new configuration parameters of CTCH;
(6) BMC adds descriptions for Multimedia Broadcast/Multicast Service (MBMS) service notification message to a pending-for-sending schedule message, and then BMC arranges the Multimedia Broadcast/Multicast Service (MBMS) service notification message on a specific position of a schedule period following the schedule message for future sending;
(7) BMC sends the schedule message; and
(8) BMC sends the Multimedia Broadcast/Multicast Service (MBMS) service notification message at the prescribed time.

14. The method according to claim 12, wherein the step of UE receiving the Multimedia Broadcast/Multicast Service (MBMS) service notification message via cell broadcast further comprises the following steps:
(1) Multimedia Broadcast/Multicast Service Control Module (MBMSC) sends a request to BMC with a first primitive for receiving a service announcement message or a service notification message of Multimedia Broadcast/Multicast Service (MBMS);
(2) If BMC hasn't received any broadcast message before, proceeding to step (3); otherwise, proceeding to step (9);
(3) BMC informs RRC to receive broadcast message with a second primitive, which includes the parameters that can inform RRC only to receive a BMC preferred message at the prescribed time and to skip some messages;
(4) If RRC has not configured CTCH before, RRC configures link layer (L2) and physical layer (L1) to enable UE to receive information on the CTCH and feedbacks necessary CTCH configuration information with a third primitive to BMC at the same time, thereafter proceeding to step (5); if RRC has configured CTCH resources before, proceeding to step (5) directly;
(5) According to the requirement of BMC, RRC controls L2 and L1 with a fourth primitive to receive cell broadcast information on the CTCH at the prescribed time;
(6) After processing the data frame received from the CTCH accordingly, L1 and L2 submit it to BMC in the format of BMC message with a fifth primitive;
(7) BMC analyses the received message, and if it is the service announcement message or service notification message of Multimedia Broadcast/Multicast Service (MBMS), BMC forwards it to Multimedia Broadcast/Multicast Service Control Module (MBMSC) with a sixth primitive, at the same time the reception is completed; if it is not the service announcement message or service notification message of Multimedia Broadcast/Multicast Service (MBMS), proceeding to step (8);
(8) If the message received by BMC is the schedule message, proceeding to step (9); otherwise, proceeding to step (3);
(9) BMC analyses the schedule message that was received most recently, and checks whether the schedule period described by the schedule message includes the service announcement message or service notification message of Multimedia Broadcast/Multicast Service (MBMS) or not, and if it is positive, proceeding to step (12), otherwise, BMC finds the position of the next schedule message and requests RRC to receive the next schedule message with the second primitive;
(10) RRC controls L1 and L2 to receive the next schedule message at the prescribe time with the fourth primitive;
(11) After processing the message received from the CTCH accordingly, L1 and L2 forward the schedule message to BMC with the fifth primitive, and then proceeding to step 9);
(12) BMC finds the position of the Multimedia Broadcast/Multicast Service (MBMS) service announcement message or service notification message, and requests RRC to receive Multimedia Broadcast/Multicast Service (MBMS) service announcement message or service notification message at the prescribed time with the second primitive;
(13) RRC controls L1 and L2 to receive the Multimedia Broadcast/Multicast Service (MBMS) service announcement message or service notification message at the prescribed time with the fourth primitive;
(14) After processing the message received from the CTCH accordingly, L1 and L2 forward the Multimedia Broadcast/Multicast Service (MBMS) service announcement message or service notification message to BMC with the fifth primitive;
(15) BMC forwards the Multimedia Broadcast/Multicast Service (MBMS) service announcement message or service notification message to Multimedia Broadcast/Multicast Service (MBMS) with the third primitive and the reception is completed.

15. A method for transferring a service notification of broadcast service in Multimedia Broadcast/Multicast Service (MBMS) comprises the following steps:
(a) BM_SC sends the Multimedia Broadcast/Multicast Service (MBMS) data to GGSN;
(b) After receiving said data sent by BM_SC, GGSN sends said data to SGSN by tunneling technique;
(c) After receiving the signals from GGSN, SGSN informs UMTS Terrestrial Radio Access Network (UTRAN) of the forthcoming of the Multimedia Broadcast/Multicast Service (MBMS) data via a signaling message;
(d) establishing Radio data Access Bearer (RAB) between UMTS Terrestrial Radio Access Network (UTRAN) and SGSN;
(e) SGSN sends the Multimedia Broadcast/Multicast Service (MBMS) data to UMTS Terrestrial Radio Access Network (UTRAN) via Radio data Access Bearer RAB;
(f) UMTS Terrestrial Radio Access Network (UTRAN) arranges the sending time of a Multimedia Broadcast/Multicast Service (MBMS) service notification message;
(g) UMTS Terrestrial Radio Access Network (UTRAN) sends the Multimedia Broadcast/Multicast Service (MBMS) service notification message;
(h) UMTS Terrestrial Radio Access Network (UTRAN) allocates the radio bearer (RB) according to the number of UEs;
(i) UTRAN sends the Multimedia Broadcast/Multicast Service (MBMS) data to the UE via RB.

16. The method according to claim 15, wherein that the step of UMTS Terrestrial Radio Access Network (UTRAN) sending the Multimedia Broadcast/Multicast Service (MBMS) service notification via cell broadcast further comprises the following steps:
(1) Multimedia Broadcast/Multicast Service Control Module (MBMSC) receives a signaling message sent from the core network nodes (SGSN, CBC), which informs UMTS Terrestrial Radio Access Network (UTRAN) to send a service announcement message or service notification message of Multimedia Broadcast/Multicast Service (MBMS;
(2) Multimedia Broadcast/Multicast Service Control Module (MBMSC) requests Broadcast/Multicast Control protocol (BMC) with a primitive to send the service announcement message or service notification message of Multimedia Broadcast/Multicast Service (MBMS;
(3) BMC constructs the service announcement message or service notification message of Multimedia Broadcast/Multicast Service (MBMS);
(4) BMC estimates the transmission rate (Vneed) needed on the CTCH;
(5) RRC controls L1 and L2 with a primitive to establish CTCH or adjust CTCH configuration to make CTCH transmission rate match;
(6) BMC adds descriptions for the service announcement message or service notification message of Multimedia Broadcast/Multicast Service (MBMS) to a pending-for-sending schedule message; and
(7) BMC sends the schedule message; and
(8) BMC sends the service announcement message or service notification message of Multimedia Broadcast/Multicast Service (MBMS) at the prescribed time.

17. The method according to claim 15, wherein the step of UE receiving the Multimedia Broadcast/Multicast Service (MBMS) service notification message via Cell Broadcast further comprises the following steps:
(1) Multimedia Broadcast/Multicast Service Control Module (MBMSC) sends a request to BMC with a first primitive for receiving a service announcement message or a service notification message of Multimedia Broadcast/Multicast Service (MBMS);
(2) If BMC hasn't received any broadcast message before, proceeding to step (3); otherwise, proceeding to step (9);
(3) BMC informs RRC to receive broadcast message with a second primitive, which includes the parameters that can inform RRC only to receive a BMC preferred message at the prescribed time and to skip some messages;
(4) If RRC has not configured CTCH before, RRC configures link layer (L2) and physical layer (L1) to enable UE to receive information on the CTCH and feedbacks necessary CTCH configuration information with a third primitive to BMC at the same time, thereafter proceeding to step (5); if RRC has configured CTCH resources before, proceeding to step (5) directly;
(5) According to the requirement of BMC, RRC controls L2 and L1 with a fourth primitive to receive cell broadcast information on the CTCH at the prescribed time;
(6) After processing the data frame received from the CTCH accordingly, L1 and L2 submit it to BMC in the format of BMC message with a fifth primitive;
(7) BMC analyses the received message, and if it is the service announcement message or service notification message of Multimedia Broadcast/Multicast Service (MBMS), BMC forwards it to Multimedia Broadcast/Multicast Service Control Module (MBMSC) with a sixth primitive, at the same time the reception is completed; if it is not the service announcement message or service notification message of Multimedia Broadcast/Multicast Service (MBMS), proceeding to step (8);
(8) If the message received by BMC is the schedule message, proceeding to step (9); otherwise, proceeding to step (3);
(9) BMC analyses the schedule message that was received most recently, and checks whether the schedule period described by the schedule message includes the service announcement message or service notification message of Multimedia Broadcast/Multicast Service (MBMS) or not, and if it is positive, proceeding to step (12), otherwise, BMC finds the position of the next schedule message and requests RRC to receive the next schedule message with the second primitive;
(10) RRC controls L1 and L2 to receive the next schedule message at the prescribe time with the fourth primitive;
(11) After processing the message received from the CTCH accordingly, L1 and L2 forward the schedule message to BMC with the fifth primitive, and then proceeding to step 9);
(12) BMC finds the position of the Multimedia Broadcast/Multicast Service (MBMS) service announcement message or service notification message, and requests RRC to receive Multimedia Broadcast/Multicast Service (MBMS) service announcement message or service notification message at the prescribed time with the second primitive;
(13) RRC controls L1 and L2 to receive the Multimedia Broadcast/Multicast Service (MBMS) service announcement message or service notification message at the prescribed time with the fourth primitive;
(14) After processing the message received from the CTCH accordingly, L1 and L2 forward the Multimedia Broadcast/Multicast Service (MBMS) service announcement message or service notification message to BMC with the fifth primitive;
(15) BMC forwards the Multimedia Broadcast/Multicast Service (MBMS) service announcement message or service notification message to Multimedia Broadcast/Multicast Service (MBMS) with the third primitive and the reception is completed.

18. A method of sending Multimedia Broadcast/Multicast Service (MBMS) multicast service data in a communication system comprises the following steps:
sending a service announcement message that includes the parameters of the service types and service areas of Multimedia Broadcast/Multicast Service (MBMS) via cell broadcast;
establishing a transmission bearer for the Multimedia Broadcast/Multicast Service (MBMS) multicast service;
sending a service notification information for the arrival of the Multimedia Broadcast/Multicast Service (MBMS) data via cell broadcast;
sending the Multimedia Broadcast/Multicast Service (MBMS) multicast service data; and
releasing the transmission bearer after the Multimedia Broadcast/Multicast Service (MBMS) service.

19. A method of receiving Multimedia Broadcast/Multicast Service (MBMS) multicast service data in a communication system comprises the following steps:
receiving service announcement information for the parameters of the service types and service areas of Multimedia Broadcast/Multicast Service (MBMS) via cell broadcast;
joining a specific Multimedia Broadcast/Multicast Service (MBMS) multicast service;
receiving service notification information for the arrival of Multimedia Broadcast/Multicast Service (MBMS) via a MBMS channel;
receiving the Multimedia Broadcast/Multicast Service (MBMS) multicast service data; and
releasing the MBMS channel for leaving the specific Multimedia Broadcast/Multicast Service (MBMS) multicast service.

20. A method of sending Multimedia Broadcast/Multicast Service (MBMS) broadcast service data in a communication system comprises the following steps:
UMTS Terrestrial Radio Access Network (UTRAN) sends a service announcement message that includes the parameters of the service types and service areas of Multimedia Broadcast/Multicast Service (MBMS) via cell broadcast;
UMTS Terrestrial Radio Access Network (UTRAN) and the apparatuses in core network co-establish network resources for the Multimedia Broadcast/Multicast Service (MBMS) broadcast service;
UMTS Terrestrial Radio Access Network (UTRAN) sends service notification information for the arrival of the Multimedia Broadcast/Multicast Service (MBMS) data via cell broadcast;
UMTS Terrestrial Radio Access Network (UTRAN) sends the Multimedia Broadcast/Multicast Service (MBMS) multicast service data; and
UMTS Terrestrial Radio Access Network (UTRAN) and other apparatuses in the core network co-release network resources used for the Multimedia Broadcast/Multicast Service (MBMS) broadcast service.

21. A method of receiving Multimedia Broadcast/Multicast Service (MBMS) broadcast service data in a communication system comprises the following steps:
UE receives service announcement information for the parameters of the service types and service areas of Multimedia Broadcast/Multicast Service (MBMS) via cell broadcast;
UE receives service notification information for the arrival of Multimedia Broadcast/Multicast Service (MBMS) data via cell broadcast;
UE receives the Multimedia Broadcast/Multicast Service (MBMS) broadcast service data.
